(19) United States
(12) Patent Application Publication
(10) Pub. No.: US 2026/0001336 A1
(43) Pub. Date: Jan. 1, 2026

(54) INTERLEAVABLE LOW-COST INKJET PRINTHEAD

(71) Applicant: MEMJET TECHNOLOGY LIMITED, Dublin 2 (IE)

(72) Inventors: Jason Thelander, North Ryde (AU); Norman Berry, North Ryde (AU); David Burke, North Ryde (AU); Mark Profaca, North Ryde (AU); Robert Smeallie, North Ryde (AU)

(21) Appl. No.: 19/240,937

(22) Filed: Jun. 17, 2025

Related U.S. Application Data
(60) Provisional application No. 63/666,377, filed on Jul. 1, 2024.
(60) Provisional application No. 63/668,497, filed on Jul. 8, 2024.

(51) Int. Cl. B41J 2/175; B41J 2/14; B41J 2/21

(52) U.S. Cl. CPC B41J 2/17523; B41J 2/2103; B41J 2002/14419; B41J 2002/14491; B41J 2202/20

(57) ABSTRACT

An inkjet printhead includes: an elongate manifold having a longitudinal central portion extending along a central longitudinal axis of the printhead; first and second longitudinal channel portions extending along respective longitudinal axes at opposite sides of the central portion; and first and second rows of butting print chips mounted to a base of the manifold, the first row of print chips extending along the first channel portion and the second row of print chips extending along the opposite second channel portion. Each of the first and second channel portions extends beyond the central portion at opposite ends of the manifold, such that respective opposite ends of the manifold have a re-entrant profile configured for complementary interleaving of a plurality of said printheads.

### CROSS-REFERENCE TO RELATED APPLICATIONS

This application claims the benefit of priority to co-owned and co-pending U.S. Provisional Patent Application Ser. No. 63/666,377 filed Jul. 1, 2024, and entitled “LOW-COST INKJET PRINTHEAD FOR REDUNDANT PRINTING”, as well as co-owned and co-pending U.S. Provisional Patent Application Ser. No. 63/668,497 filed Jul. 8, 2024, and entitled “INTERLEAVABLE LOW-COST INKJET PRINTHEAD”, the contents of each of the foregoing being incorporated herein by reference in their entireties.

### TECHNOLOGICAL FIELD

This present disclosure relates to an inkjet printhead. It has been developed primarily to provide a robust, full-color printhead suitable for high quality pagewide printing in a modular array of stitched printheads.

### BACKGROUND

The Applicant has developed a range of Memjet® inkjet printers as described in, for example, WO2011/143700, WO2011/143699 and WO2009/089567, the contents of which are incorporated herein by reference in their entireties. Memjet® printers employ one or more stationary inkjet printheads in combination with a feed mechanism which feeds print media past the printhead in a single pass. Memjet® printers therefore provide much higher printing speeds than conventional scanning inkjet printers.

Digital presses suitable for relatively short print runs represent a significant market opportunity for pagewide printing technology. Pagewide inkjet printing units may be used to replace traditional analogue printing plates in an offset press without significant modifications to expensive media feed systems. The present Applicant has developed printing systems suited to the needs of OEMs wishing to upgrade existing offset presses to high-speed digital inkjet presses. For example, U.S. Pat. No. 10,099,494 (the contents of which being incorporated herein by reference in its entirety) describes a modular printing system comprising monochrome print bars having one or more print modules. Each print module has 5× redundancy by virtue of 5 nozzle rows in a respective printhead, providing high quality, high speed printing suited to the requirements of inkjet press OEMs. The modular printing system may be configured for full color printing by stacking monochrome print bars along a media feed path, as described in U.S. Pat. No. 10,099,494.

Notwithstanding these improvements in modular inkjet printing systems, there is still a need to improve such systems further. One disadvantage of using an array of monochrome print bars is that the overall span of the print zone along the media feed direction is relatively long. Even with innovative measures to minimize inter-print bar separation, the print zone for four print bars (e.g. CMYK print bars) may still be up to 500 mm or up to 1000 mm in length along the media feed path. Longer print zones create challenges, not only in terms of alignment and accurate dot-on-dot placement, but also integration into an existing offset media feed system. For example, limited space may be available for an inkjet print engine in the media feed path and reconfiguring media feed systems to accommodate such a print engine is costly for OEMs.

With a sufficiently narrow print zone, pagewide printheads may be suitable for use in office-type printers, particularly high-end office printers. One approach to minimizing the size of the print zone is to print four colors of ink from the same printhead. For example, U.S. Pat. No. 10,293,609 describes a full-color printhead having two rows of print chips with each row printing two colors of ink with 2× redundancy. The two rows of print chips are mounted on an Invar ink manifold, which provides a high degree of stiffness compared to polymer manifolds (e.g. LCP manifolds). The rigidity of the ink manifold enables long printheads to be manufactured (see, for example, Memjet DuraFlex® and DuraBolt™ print systems having A3-sized Invar printheads). However, Invar ink manifolds necessarily add to the overall cost of such printheads. Furthermore, they are less suited to high-volume manufacturing than printheads having molded polymer ink manifolds.

It would therefore be desirable to provide a cost-effective full-color printhead with redundancy in each color. It would be further desirable to provide a versatile printhead that is suitable for stitching with similar printheads in a modular pagewide arrangement. Efficient arrangements for supplying ink, power and data to rows of print chips in the printhead would also be desirable.

### SUMMARY

In one aspect, an inkjet printhead is disclosed. In one embodiment, the inkjet printhead includes an elongate manifold having: a longitudinal central portion extending along a central longitudinal axis of the printhead; first and second longitudinal channel portions extending along respective longitudinal axes at opposite sides of the central portion and defining opposite side edges of the manifold, each channel portion having at least one longitudinal ink supply channel extending along a length thereof; and first and second rows of print chips butting end-to-end and mounted to a base of the manifold, the first row of print chips extending along the first channel portion and the second row of print chips extending along the opposite second channel portion, each print chip in the first row receiving ink from at least one ink supply channel in the first channel portion and each print chip in the second row receiving ink from at least one ink supply channel in the second channel portion, wherein each of the first and second channel portions extends beyond the central portion at opposite ends of the manifold, such that respective opposite ends of the manifold have a re-entrant profile configured for complementary interleaving of a plurality of said printheads.

Preferably, the manifold has 180 degree rotational symmetry.

Preferably, the manifold has substantial mirror symmetry about its central longitudinal axis.

Preferably, the re-entrant profile at each end of the manifold contains exterior angles from 100 to 170 degrees.

Preferably, opposite ends of the manifold have a trapezoidal wave profile for complementary interleaving of neighboring printheads.

Preferably, the printhead further comprises a first PCB mounted to the base of the manifold, the first PCB extending longitudinally along the manifold between the first and second rows of print chips.

Preferably, the first PCB extends into the first and second channel portions and has a re-entrant profile at opposite ends thereof mirroring the re-entrant profile at opposite ends of the manifold.

Preferably, the first PCB distributes power and data to both the first and second rows of print chips.

Preferably, the central portion defines a plurality of through-holes, and wherein each through-hole receives one or more electrical connectors for supplying power and data to the first PCB.

Preferably, the first channel portion contains first and second ink supply channels for supplying first and second inks to the first row of print chips, and the second channel portion contains third and fourth ink supply channels for supplying third and fourth inks to the second row of print chips.

Preferably, the manifold comprises molded upper and lower parts bonded together, wherein the lower part defines the ink supply channels and the upper part defines ink feed slots facing ink supply channels, each ink feed slot being co-extensive and aligned with its corresponding ink supply channel.

Preferably, each ink feed slot communicates with ink ports positioned towards opposite ends of the upper part, respectively.

Preferably, each ink supply channel meets with opposite endwalls of the lower part; each ink feed slot meets with opposite endwalls of the upper part; and each ink port is laterally offset from its respective ink feed slot and extends upwardly from the manifold.

Preferably, each ink port is longitudinally spaced apart from a respective endwall of the upper part, and wherein an ink passage interconnects the ink port with its respective ink feed slot.

Preferably, the ink port, the ink passage and the ink feed slot define a tortuous ink pathway.

Preferably, the first channel portion contains first and second ink feed slots corresponding to first and second ink supply channels; and the second channel portion contains third and fourth ink feed slots corresponding to third and fourth ink supply channels.

Preferably, each ink feed slot communicates with a respective pressure dampener positioned above its respective ink feed slot, the pressure dampener comprising a membrane gasket configured for flexing in response to pressure fluctuations.

Preferably, each ink feed slot has a respective ink duct communicating ink pressure fluctuations from the ink feed slot to the membrane gasket, each ink duct having a larger volume than its corresponding ink feed duct to provide a locak ink reservoir supplying ink to the print chips.

Preferably, each pair of first and second ink ducts corresponding to first and second ink feed slots is covered by a respective first cover plate, the first cover plate urging a first membrane gasket against first and second duct walls to seal the first and second ink ducts; and each pair of third and fourth ink ducts corresponding to third and fourth ink feed slots is covered by a respective second cover plate, the second cover plate urging a second membrane gasket against third and fourth duct walls to seal the third and fourth ink ducts.

Preferably, first and second ink ports corresponding to the first and second ink feed slots are positioned at opposite sides of the first and second ink feed slots, respectively; and third and fourth ink ports corresponding to the third and fourth feed slots are positioned at opposite sides of the third and fourth ink feed slots, respectively.

In another embodiment, the inkjet printhead includes an elongate manifold having: a longitudinal central portion extending along a central longitudinal axis of the printhead; first and second longitudinal channel portions extending along respective longitudinal axes at opposite sides of the central portion to define opposite side edges of the manifold, each channel portion having a pair of longitudinal ink supply channels extending along its length, each ink supply channel meeting with opposite endwalls of the manifold; and first and second rows of print chips butting end-to-end and mounted to a base of the manifold, the first row of print chips extending along the first channel portion and the second row of print chips extending along the opposite second channel portion, each print chip in the first row receiving ink from a respective pair of ink supply channels in the first channel portion and each print chip in the second row receiving ink from a respective pair of ink supply channels in the second channel portion, wherein: each pair of ink supply channels receives ink via a respective pair of ink inlet ports extending upwardly from the manifold; each pair of ink inlet ports is spaced away from a respective endwall of the manifold; and the inlet ports of one pair are positioned at opposite sides of a respective pair of ink supply channels.

Preferably, the manifold comprises molded upper and lower parts bonded together, wherein the lower part defines the ink supply channels and the upper part defines corresponding ink feed slots facing ink supply channels, each ink feed slot being co-extensive and aligned with its corresponding ink supply channel.

Preferably, each ink port is connected to its respective ink supply channel via a respective ink feed slot.

Preferably, an ink passage interconnects each ink port with its respective ink feed slot.

Preferably, a sidewall of at least one ink passage meets a sidewall of the ink feed passage at an acute angle.

Preferably, a sidewall of at least one ink passage is flared towards an endwall of the upper part.

Preferably, the ink port, the ink passage and the ink feed slot define a tortuous ink pathway.

Preferably, each ink feed slot communicates with a respective pressure dampener positioned above its respective ink feed slot, the pressure dampener comprising a membrane gasket configured for flexing in response to pressure fluctuations.

Preferably, each ink feed slot has a respective ink duct communicating ink pressure fluctuations from the ink feed slot to the membrane gasket, each ink duct having a larger volume than its corresponding ink feed slot to provide a local ink reservoir supplying ink to the print chips.

Preferably, a pair of first and second ink ducts corresponding to a pair first and second ink feed slots is covered by a respective first cover plate, the first cover plate urging a first membrane gasket against first and second duct walls to seal the first and second ink ducts; and a pair of third and fourth ink ducts corresponding to third and fourth ink feed slots is covered by a respective second cover plate, the second cover plate urging a second membrane gasket against third and fourth duct walls to seal the third and fourth ink ducts.

Preferably, the printhead further comprises a first PCB mounted to the base of the manifold, the first PCB extending longitudinally along the manifold between the first and second rows of print chips.

Preferably, the first PCB distributes power and data to both the first and second rows of print chips.

Preferably, the central portion defines a plurality of through-holes, and wherein each through-hole receives one or more electrical connectors for supplying power and data to the first PCB.

In another aspect, a print bar having a plurality of printheads is disclosed. In one embodiment the print bar having a plurality of printheads according as described herein in an interleaved array, whereby a first channel portion of a first printhead interleaves between first and second channel portions of a second printhead, such that: a first row of print chips of the first printhead overlaps with a corresponding first row of print chips of the second printhead; and a second row of print chips of the first printhead overlaps with a corresponding second row of print chips of the second printhead.

In yet another aspect, there is provided a plurality of printheads as described herein in a staggered overlapping array.

In yet another aspect, there is provided a print bar comprising a plurality of elongate print modules positioned in a staggered overlapping array, each print module having an inlet port at one end and an outlet port at an opposite end thereof, wherein: the outlet port of one printhead is connected to the inlet port of a neighboring printhead via an ink connector; and the ink connector comprises a flexible film configured for dampening ink pressure fluctuations.

Preferably, each print module comprises one or more longitudinal ink supply channels, each ink supply channel having a respective local pressure dampener, and wherein the local pressure dampeners cooperate with at least one flexible film to dampen ink pressure fluctuations along a length of the print bar.

Preferably, the local pressure dampener comprises a membrane gasket communicating with the ink supply channel.

Preferably, each membrane gasket is positioned above its respective ink supply channel.

Preferably, each membrane gasket extends longitudinally with its respective ink supply channel and has a length less than a length of its respective ink supply channel.

Preferably, each membrane gasket is absent at end portions of each ink supply channel.

Preferably, the flexible film of the ink connector at least partially compensates for the absence of the membrane gasket at the end portions of interconnected ink supply channels.

Preferably, each print module comprises a manifold having the ink supply channels.

Preferably, ink ducts are positioned above the ink supply channels in fluid communication therewith, each ink duct having a larger volume than its respective ink supply channel to provide a local reservoir of ink supplying ink to the print chips.

Preferably, each membrane gasket is sealed against sidewalls of a respective ink duct with a cover plate, each membrane gasket being sandwiched between its respective ink duct and cover plate.

Preferably, each cover plate seals against a pair of ink ducts.

In yet another aspect, an ink connector for an inkjet printhead is disclosed. In one embodiment, the ink connector includes: a body; a plurality of ink inlet couplings extending from the body; a plurality of ink outlet couplings extending from the body; a plurality of connector channels defined in the body, each connector channel interconnecting a respective one of the ink inlet couplings with a respective one of the ink outlet couplings; and at least one flexible film communicating with each connector channel, wherein the flexible film is configured to flex in response to ink pressure fluctuations, thereby dampening said ink pressure fluctuations.

Preferably, the connector channels are formed as grooves in the body and the flexible film seals the grooves.

Preferably, the flexible film comprises one or more bellows for dampening the ink pressure fluctuations.

Preferably, each bellows hangs into a respective connector channel.

Preferably, the ink inlet couplings and the ink outlet couplings extend in parallel from a same side of the body for interconnecting ink ports of neighboring print modules in modular print bar.

In yet another aspect, a printhead assembly is disclosed. In one embodiment, the printhead assembly includes an elongate manifold having first and second relatively longer portions flanking a relatively shorter central portion, the first and second relatively longer portions having corresponding first and seconds rows of print chips mounted thereon, each row containing a plurality of print chips butting end-to-end along a length of the printhead assembly, wherein the printhead assembly has at least partial 180 degree rotational symmetry.

Preferably, the printhead assembly further comprises a first PCB positioned between the first row of print chips and the second row of print chips.

Preferably, the first and second rows of print chips are oppositely oriented relative to each other, thereby maintaining the rotational symmetry of the printhead assembly.

Preferably, each row of print chips has bond pads positioned proximal the first PCB for wirebonding thereto.

Preferably, the first PCB receives power and data via through-holes defined in the central portion of the manifold.

Preferably, each of the first and longer portions extends beyond the central portion at opposite ends of the manifold, such that respective opposite ends of the manifold have a re-entrant profile configured for complementary interleaving of a plurality of said printheads.

Preferably, the re-entrant profile at each end of the manifold contains exterior angles from 100 to 170 degrees.

Preferably, opposite ends of the manifold have a trapezoidal wave profile for complementary interleaving of neighboring printheads.

Preferably, each of the first and second longer portions has at least one longitudinal ink supply channel extending along a length thereof.

Preferably, the first longer portion contains first and second ink supply channels for supplying first and second inks to the first row of print chips, and the second longer portion contains third and fourth ink supply channels for supplying third and fourth inks to the second row of print chips.

Preferably, the manifold comprises molded upper and lower parts bonded together, wherein the lower part defines the ink supply channels and the upper part defines corresponding ink feed slots facing ink supply channels, each ink feed slot being co-extensive and aligned with its corresponding ink supply channel.

Preferably, each ink feed slot communicates with a respective pressure dampener positioned above its respective ink feed slot, the pressure dampener comprising a membrane gasket configured for flexing in response to pressure fluctuations.

Preferably, each ink feed slot has a respective ink duct communicating ink pressure fluctuations from the ink feed slot to the membrane gasket, each ink duct having a larger volume than its corresponding ink feed slot to provide a local ink reservoir supplying ink to the print chips.

Preferably, a pair of first and second ink ducts corresponding to a pair first and second ink feed slots is covered by a respective first cover plate, the first cover plate urging a first membrane gasket against first and second duct walls to seal the first and second ink ducts; and a pair of third and fourth ink ducts corresponding to third and fourth ink feed slots is covered by a respective second cover plate, the second cover plate urging a second membrane gasket against third and fourth duct walls to seal the third and fourth ink ducts.

In yet another aspect, there is provided an inkjet printhead comprising the printhead assembly described herein.

Preferably, the inkjet printhead is configured for configured for complementary interleaving of a plurality of said printheads.

In yet another aspect, there is provided a plurality of interleaved inkjet printheads as described herein.

As used herein, the term “ink” is taken to mean any printing fluid, which may be printed from an inkjet printhead. The ink may or may not contain a colorant. Accordingly, the term “ink” may include conventional dye-based and pigment-based inks, infrared inks, UV inks, fixatives (e.g. pre-coats and finishers), functional fluids (e.g. solar inks, sensing inks), 3D printing fluids, biological fluids and the like. Where reference is made to fluids or printing fluids, this is not intended to limit the meaning of “ink” herein.

As used herein, the term “mounted” includes both direct mounting and indirect mounting via an intervening part.

### BRIEF DESCRIPTION OF DRAWINGS

Embodiments of the present disclosure will now be described by way of example only with reference to the accompanying drawings, in which:

FIG. 1 is a top perspective of a printhead according to a first embodiment;

FIG. 2 is a bottom perspective of the printhead shown in FIG. 1;

FIG. 3 is a top perspective of the printhead shown in FIG. 1 with an upper second PCB removed;

FIG. 4 is a top perspective of the printhead shown in FIG. 3 with cover plates removed and connector units partially removed;

FIG. 5 is a sectional perspective of the printhead shown in FIG. 1;

FIG. 6 is a top perspective of a two-part manifold in isolation;

FIG. 7 is an exploded top perspective of the two-part manifold;

FIG. 8 is an exploded bottom perspective of the two-part manifold;

FIG. 9 is a bottom plan view of one end of an upper molding of the manifold;

FIG. 10 is a magnified view of ink outlets, print chips and a first PCB;

FIG. 11 is a bottom plan view of the printhead shown in FIG. 1;

FIG. 12 is a bottom plan view of a pair of interleaved printheads;

FIG. 13 is a top perspective of a print bar with one set of ink connectors removed; and

FIG. 14 shows one ink connector between ink inlet and outlet ports of neighboring printheads.

### DETAILED DESCRIPTION

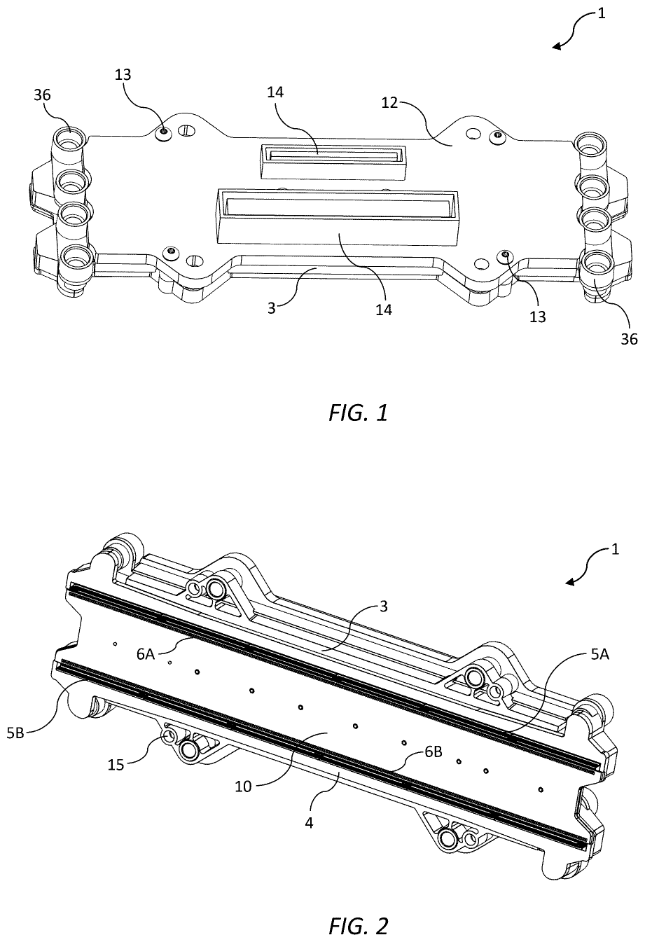

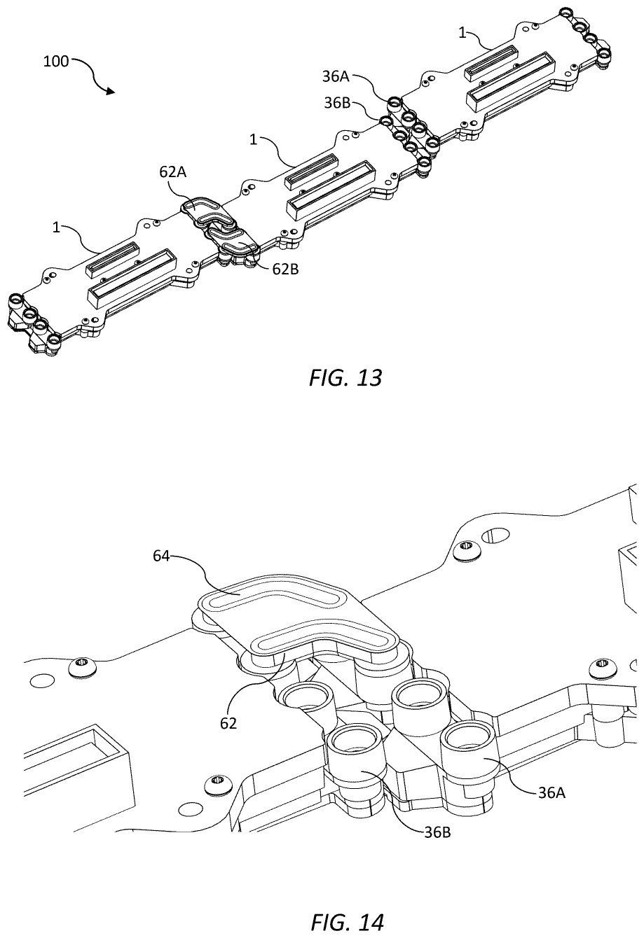

Referring to FIGS. 1 to 14, there is shown an inkjet printhead 1 (or sometimes “print module” when used in a modular array of the type shown in FIG. 13) and print bar 100 according to one aspect of the present disclosure. The printhead 1 typically has a length of 100 to 150 mm and, as will be described below, the printhead is configured for constructing a modular pagewide array of interleaved print modules suitable for printing over wider media widths (e.g. A3 or wider). Advantageously, modular pagewide arrays comprising multiple interleaved printheads 1 are capable of printing in full-color with redundancy in each color channel, have a relatively narrow print zone span along the media feed direction, and can be manufactured at relatively low cost compared to, for example, A3-sized printheads of the type described in U.S. Pat. No. 10,293,609.

As best shown in FIG. 2, the printhead 1 comprises an elongate manifold 3 configured for supplying ink and power/data to a first row of print chips 5A and a second row of print chips 5B mounted to a lower face 4 thereof. Additionally, a first PCB 10 is mounted to a recessed portion of the lower face 4 between the first and second rows of print chips 5A and 5B. The first PCB 10 extends generally co-extensively with the rows of print chips along the length of the printhead 1 and distributes power and data to both the first row 5A and the second row 5B of print chips via respective first and second rows of contact pads 6A and 6B disposed along each of its opposite longitudinal edges, which extend parallel with the rows of print chips. Referring briefly to FIG. 10, individual contact pads 6 of the first PCB 10 are electrically connected to respective bond pads 8 extending along longitudinal edges of the print chips 5 via suitable wirebonds (not shown). Accordingly, the first and second rows of print chips 5A and 5B are oppositely oriented relative to each other, which enables their respective bonds pads 8 to be positioned proximal the first PCB 10 for connection to the contact pads 6.

Each of the first and second rows of print chips 5A and 5B typically contains six individual print chips 5 butted end-on-end for a total of twelve print chips in the printhead 1. Of course, a greater or fewer number of print chips 5 may be provided in each row (e.g. 3 to 8 print chips). Print chips 5 configured for butting end-on-end in a pagewide arrangement will be known to the person skilled in the art. For example, the Applicant's dropped nozzle triangle architecture for linking print chips in a row is described in U.S. Pat. No. 7,290,852, the contents of which are incorporated herein by reference in its entirety.

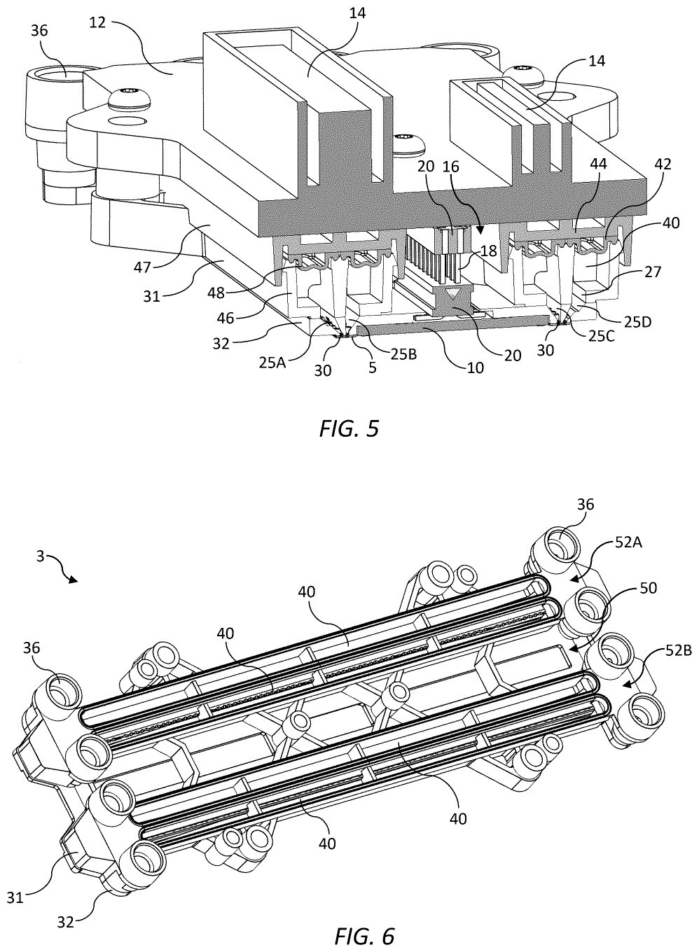

As shown in FIGS. 1 and 5, a second PCB 12 is fastened to an upper face of the manifold 3 (via screw fasteners 13 received in screw bosses 15) and extends parallel with the first PCB 10 mounted to the lower face 4 of the manifold. The second PCB 12 communicates power and data signals to the first PCB 10, as well as providing a rigid backbone for the printhead 1. For this latter requirement, the second PCB 12 is comprised of a rigid polymer substrate (e.g. conventional FR4 substrate) with a thickness of at least 3 mm, or a thickness in the range of 3 mm to 5 mm. Optionally, a thickness of the manifold 3 relative to a thickness of the second PCB 12 may be in the range of 2:1 to 4:1 in order to maximize the stiffness of the manifold 3 (and printhead 1). Power and data ports 14 extend from an upper surface of the second PCB 12 for connection to an external print controller and/or power source (not shown)

The first PCB 10 receives power and data from the second PCB 12 via through-holes 16 defined through a thickness of the manifold 3 and positioned along a central longitudinal axis thereof. Each through-hole 16 receives a plurality of electrical connector pins 18, which interconnect the first PCB 10 with the second PCB 12. Upper and lower insulator blocks 20 group the connector pins 18 into discrete connector units 22, which can be readily assembled and placed in respective through-holes 16 during manufacturing.

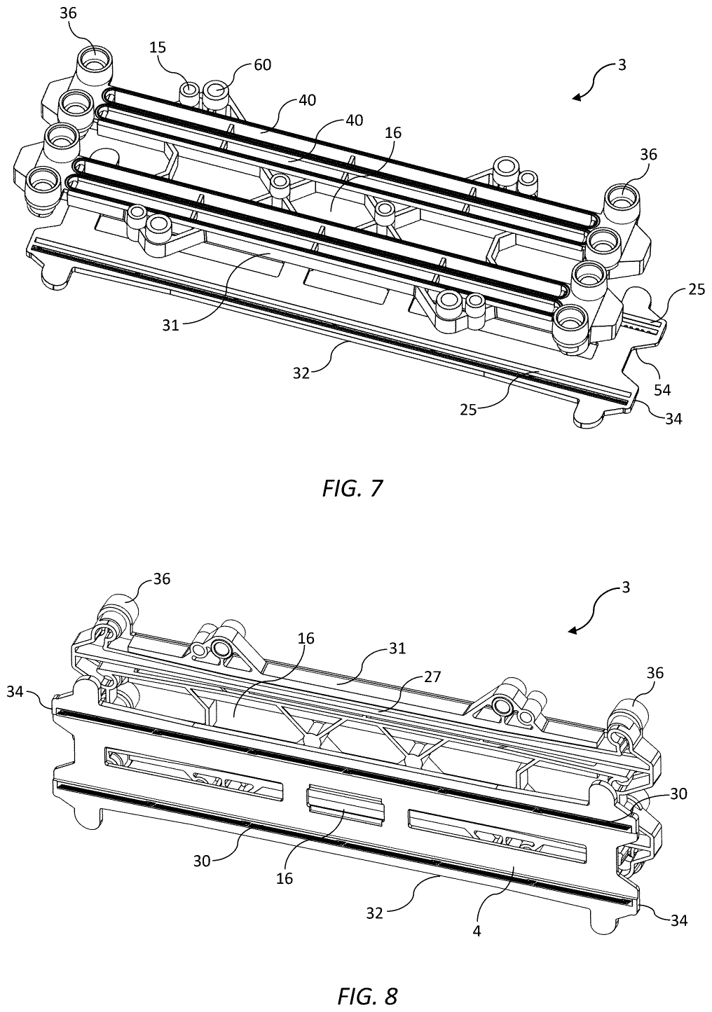

The manifold 3 typically takes the form of an LCP molding, which may be manufactured in high volumes and at relatively low cost. For ease of manufacturing, and as best shown in the exploded views of FIGS. 7 and 8, the manifold 3 exemplified herein is a two-part LCP molding having an upper molding 31 and a lower molding 32 bonded together with a suitable adhesive. While a two-part LCP molding is exemplified herein, it will of course be appreciated that the manifold 3 may be a one-part molding or a multi-part molding having three or more bonded parts.

The lower molding 32 defines four ink supply channels 25 extending along its length and suitable for supplying four colors of ink (e.g. CMYK) to the first and second rows of print chips 5A and 5B (two colors per row of print chips). The ink supply channels 25 are tapered towards rows of ink outlets 30 defined in the base of the lower molding 32, each respective pair of ink supply channels supplying ink to a paired row of ink outlets 30 defined in the base of the lower molding 32, which in turn feed ink into the backsides of print chips 5 contained in either the first row 5A or the second row 5B.

As described in U.S. Pat. No. 10,293,609, each print chip 5 has two pairs of backside channels with each pair of backside channels receiving the same-colored ink for redundant two-color printing. The print chips 5 are designed with a strip of silicon between the two pairs of backside channels to facilitate adhesive bonding and fluidic sealing of the two ink pathways. In this configuration, a Memjet® print chip with five color planes has a central non-firing row of nozzles unplumbed, leaving two pairs of color planes for redundant printing in two colors. The print chips 5 may be mounted to the manifold 3 via a suitable shim, as described in U.S. Pat. No. 10,293,609, via a die-attach film as described in U.S. Pat. No. 7,347,534 (the contents each of the foregoing being incorporated herein by reference in their entireties), or via direct adhesive bonding, as shown in FIGS. 5 and 10.

Referring to FIG. 5, first and second ink supply channels 25A and 25B are positioned at a one side of the through-holes 16 for supplying two colors of ink to the first row of print chips 5A, while third and fourth ink supply channels 25C and 25D are positioned at an opposite side of the through-holes 16 for supplying another two colors of ink to the second row of print chips 5B. For CMYK printing, and as described in U.S. Pat. No. 10,293,609, each print chip 5 prints redundantly in two colors using two pairs of nozzle rows for high-quality printing. Of course, fewer ink colors may be supplied to the two rows of print chips via the four ink supply channels 25 depending on the desired printhead configuration (e.g. monochrome printhead, two-color printhead, etc.).

The upper molding 31 is configured to supply ink to the ink supply channels 25 of the lower molding 32 via corresponding ink feed slots 27 defined in a lower surface of the upper molding. Each ink feed slot 27 is aligned with a respective one of the ink supply channels 25 and is co-extensive therewith. Since each ink supply channel 25 extends longitudinally along an entire length of the lower molding 32 from one endwall 34 to an opposite endwall of the manifold 3, then each corresponding ink feed slot 27 similarly extends along an entire length of the manifold. In this way, the two rows of print chips 5A and 5B receiving ink from the ink supply channels 25 can extend along an entire length of the manifold 3 (and printhead 1) without being starved of ink towards end regions of the manifold. Maximizing the printable length of the printhead 1 is advantageous for constructing interleaved modular arrays of such printheads, as will be explained in more detail below.

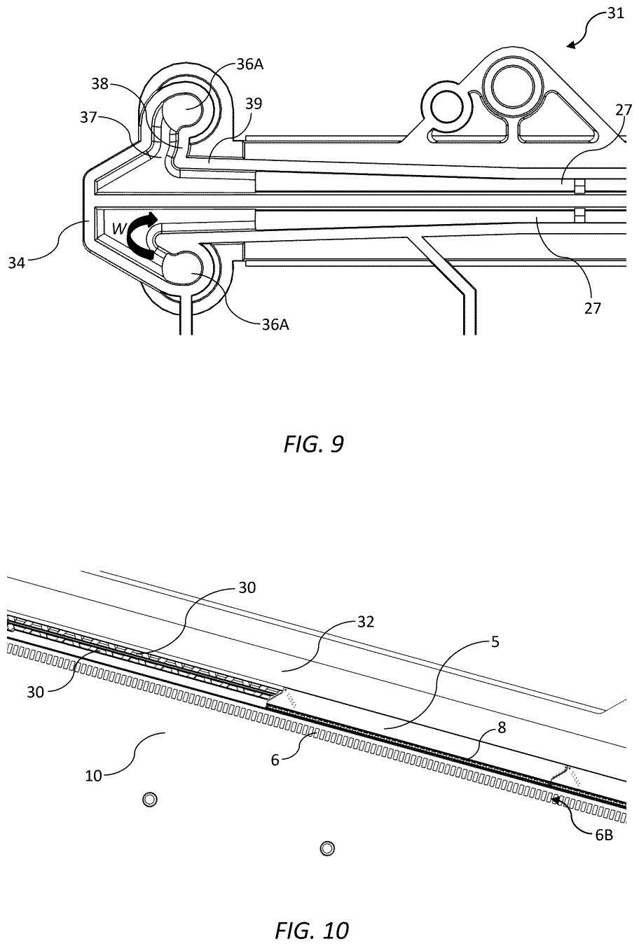

Referring to FIGS. 8 and 9, the upper manifold 31 enables the ink feed slots 27 (and thereby the ink supply channels 25) to extend along an entire length of manifold 3 by laterally offsetting ink ports 36 from the ink feed slots and spacing the ink ports inwardly away from endwalls 34 of the manifold 3. Therefore, for each neighboring pair of ink feed slots 27, the corresponding ink ports 36 are positioned relatively distally at opposite sides thereof. Each ink port 36 extends upwardly from the manifold 3 for convenient connection to an ink source (not shown) or connection to a neighboring printhead 1 (see FIG. 13).

Typically, each ink feed slot 27 is supplied with ink from one ink port (nominally ink inlet port 36A) positioned towards one end of the manifold 3 and ink exits the ink feed slot via another ink port (nominally ink outlet port 36B) positioned towards an opposite end of the manifold. As shown most clearly in FIG. 9, each ink inlet port 36A meets with a lower face of the upper manifold 31 so as to supply ink to its corresponding ink feed slot 27 via a respective interconnecting ink passage 37. Each ink passage 37 is flared towards and meets with an end region of its respective ink feed slot 27, thereby ensuring sufficient ink flow to end regions of the manifold 3. By virtue of the positioning of each ink port 36, one sidewall 38 of the ink passage 37 meets with a sidewall 39 of the ink feed slot 27 at an acute angle, such that a flow of ink (indicated by arrow W in FIG. 9) from the ink passage to the ink feed slot is at least partially reversed as it bends around the acute angle. It will, of course, be appreciated that ink outlet ports 36B at the opposite end of the ink feed slots 27 follow a similar ink pathway to enable the ink feed slots to extend along an entire length of the manifold 3 (and printhead 1) between the opposite endwalls 34.

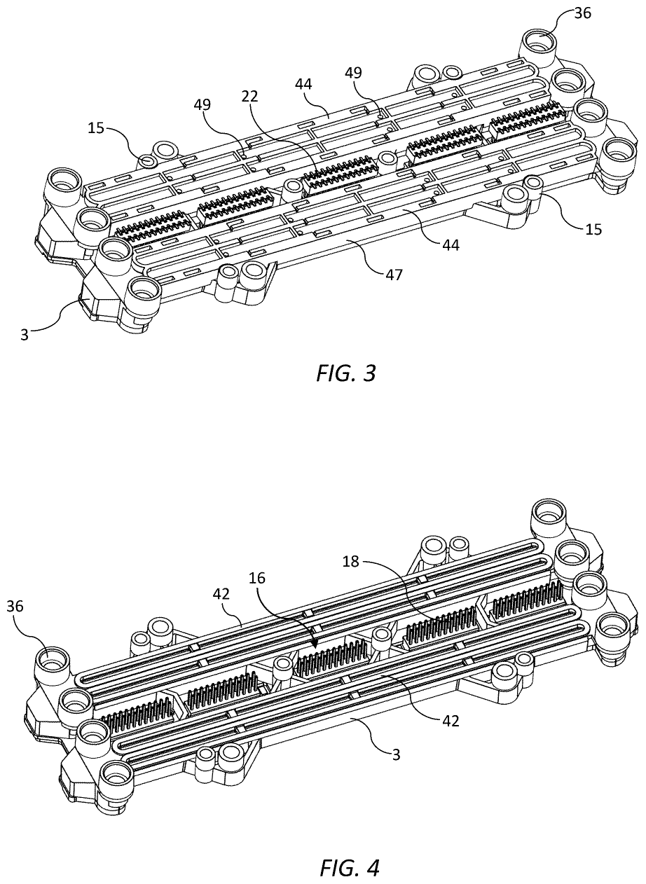

Returning to FIGS. 3 to 7, the upper molding 31 defines ink ducts 40 extending longitudinally along the manifold 3, each ink duct opening into its corresponding ink feed slot 27 defined in a base of the upper molding. Each ink duct 40 has a larger volume than its corresponding ink feed slot 27 to provide a local reservoir of ink for the print chips 5. The ink ducts 40 have roofs capped with a membrane gasket 42 while a cover plate 44 urges the membrane gasket into sealing engagement against upper parts of duct walls 46 (see FIG. 5). As shown in FIGS. 3 and 5, each pair of ink ducts 40 is covered with one cover plate 44, which may be formed of any suitable material (e.g. polymer). Flanges 47 extending downwardly from the cover plate 44 engage with the upper molding 31 via snap-fitting engagement to seal the membrane gaskets 42 against the duct walls 46.

As described in U.S. Pat. No. 10,293,609, each membrane gasket 42 is flexible and allows dampening of ink pressure fluctuations along the ink supply channels 25. Bellows 48 or hanging portions are spaced apart along the length of each membrane gasket 42 to optimize dampening of pressure fluctuations, while vents 49 in each cover plate 44 enable the underlying membrane gaskets to flex freely in response to ink pressure fluctuations.

As will be readily apparent from the drawings, and referring now to FIGS. 6, 11 and 12, the manifold 3 as a whole comprises a longitudinal central portion 50 extending along a central longitudinal axis C of the printhead with first and second longitudinal channel portions 52A and 52B extending along respective longitudinal axes at either side of the central portion. The first channel portion 52A contains the first and second ink supply channels 25A and 25B (as well as corresponding ink feed slots 27), while the second channel portion 52B contains the third and fourth ink supply channels 25C and 25D (as well as corresponding ink feed slots 27).

More particularly, each of the first and second channel portions 52A and 52B extends beyond the central portion 50 at opposite ends of the manifold 3, so as to define a re-entrant portion 54 at each end of the manifold. This re-entrant portion 54 is specifically configured for complementary interleaving with a neighboring printhead (see FIG. 12). Furthermore, the manifold 3 has multiple axes of symmetry providing versatility for use in an interleaved arrangement of printheads. Specifically, the manifold has 180 degree rotational symmetry enabling interleaving in both ‘forward’ and ‘reverse’ orientations, as well as substantial mirror symmetry about the central longitudinal axis C and about a transverse axis perpendicular to the central longitudinal axis. (By “substantial mirror symmetry”, it is meant that the manifold 3 has reflective symmetry, notwithstanding minor features of the ink outlets 30 that may not have perfect reflective symmetry by virtue of the requirement to feed ink to join regions of linked print chips)

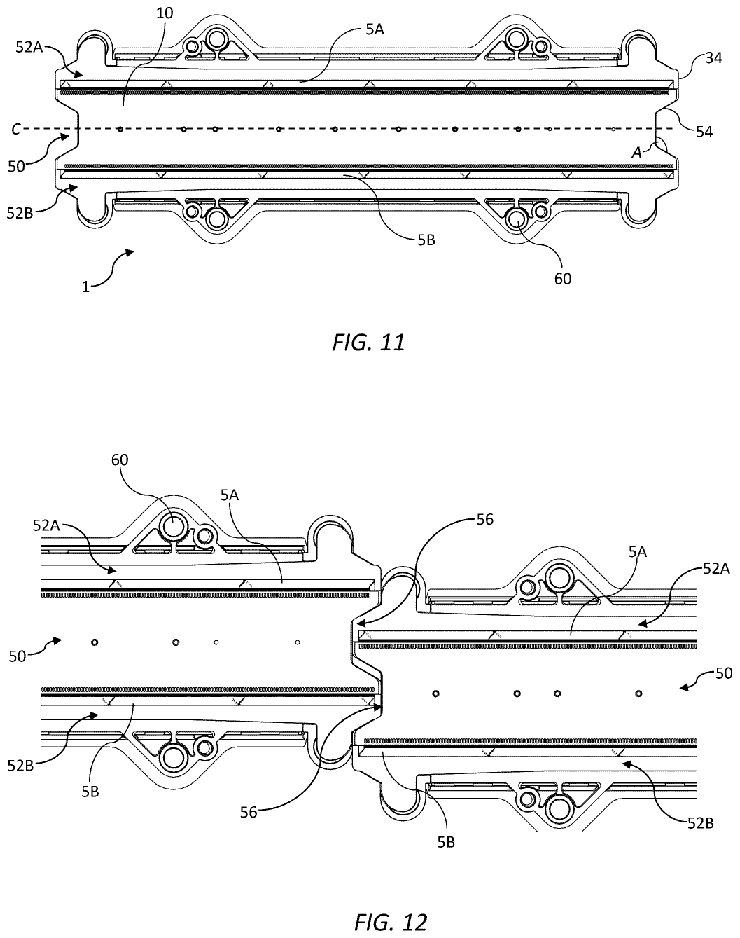

The re-entrant portion 54 at each end of the manifold contains exterior angles (one exterior angle shown as angle A in FIG. 11) in the range of 100 to 150 degrees or 110 to 130 degrees and, as shown in the present embodiment, each re-entrant portion is generally trapezoidal. The first PCB 10 generally mirrors this profile at respective opposite ends thereof, having trapezoidal re-entrant portions similar to the manifold 3.

The profile at each end of the manifold 3 (and correspondingly the first PCB 10) represents a balance between providing sufficient overlap of print chips 5 in an interleaved array versus providing sufficient power to print chips at the longitudinal extremities of the printhead 1 via the first PCB 10, while at the same time maintaining an acceptable distance between the first and second rows of print chips 5A and 5B. The present inventors have found that exterior angles A in the range of 110 to 130 degrees (e.g. about 120 degrees) provide an excellent balance between these competing considerations.

From the foregoing, it will be appreciated that the printhead 1 achieves a compact and cost-effective means of printing redundantly in four ink colors from a single printhead. In particular, the distribution of power and data from a common first PCB 10 positioned between the two rows of print chips obviates the requirement for more complex electrical routing dedicated to each row of print chips. Furthermore, the rigid second PCB 12 allows construction of the two-part manifold 3 from a moldable liquid crystal polymer, whilst maintaining sufficient structural rigidity for a printhead having dual rows of print chips with multiple print chips in each row (e.g. 2 to 11 print chips or 4 to 8 print chips per row).

Moreover, the printhead 1 is specifically configured for use in an interleaved array of multiple print modules. As will be readily apparent from FIGS. 11 and 12, the endwalls 34 of the manifold 3 (including the first channel portion 52A, the central portion 50 and the second channel portion 52B) follow a generally trapezoidal wave profile 56 for optimal interleaving of printheads. By virtue of these interleavable trapezoidal wave profiles 56 at opposite ends of the printhead 1, interleaving of neighboring printheads advantageously minimizes a span of the print zone in the media feed direction. By minimizing the span of the print zone, complex media feed mechanisms required to maintain media stability over longer print zones may be obviated. Hitherto, modular interleavable full-color printheads with redundancy in each color channel and a minimal print zone span were not known in the art.

Referring to FIG. 13 there is shown a modular print bar 100 comprising three printheads 1 (or “print modules”) in an interleaved overlapping array. With twelve print chips in each printhead (six print chips per row), the print bar is 100 suitable for A3-sized printing. Mounting lugs 60 on each printhead 1 facilitate mounting the array of modules to a suitable print bar chassis (not shown).

Specifically referring to FIG. 12, an interleaved arrangement of a pair of neighboring printheads is shown. The first channel portion 52A of the right-hand printhead is received between the first and second channel portions 52A and 52B of the left-hand printhead, while the second channel portion 52B of the left-hand printhead is received between the first and second channel portions 52A and 52B of the right-hand printhead. The interleaved trapezoidal wave profiles 56 at the endwalls 34 of the printheads enable corresponding first and second rows of print chips 5A and 5B to overlap at the join region whilst minimizing the distance between color planes. Furthermore, maximizing the printable length of each channel portion, as described above, simplifies the interleaved design by minimizing the extent of interleaving required for overlap of corresponding rows of print chips.

Referring to FIGS. 13 and 14, the print bar 100 makes use of a daisychained ink feed arrangement along the length of the print bar, whereby an ink outlet port 36B of one printhead feeds into to an ink inlet port 36A of a neighboring printhead via an ink connector 62. Typically, a first ink connector 62A interconnects ink ports for neighboring first channel portions 52A and a second ink connector 62B interconnects ink ports for neighboring second channel portions 52B.

Referring to FIG. 14, each individual ink connector 62 is typically a molder polymer having connecting channels sealed with a flexible film 64. The flexible film 64 is configured to flex in response to ink pressure fluctuations and, therefore, the flexible film complements the membrane gaskets 42 extending along the ink ducts 40. At end regions of the manifold 3, the flexible film 64 at least partially compensates for the absence of membrane gaskets 42 at the ends of the ink feed slots 27 and ink supply channels 25. Therefore, localized pressure dampening may be maintained along the entire length of the print bar.

It will, of course, be appreciated that the present disclosure has been described by way of example only and modifications of detail may be made within the scope of the disclosure, which is defined in the accompanying claims.

1. An inkjet printhead comprising:
an elongate manifold having:
a longitudinal central portion extending along a central longitudinal axis of the printhead;
first and second longitudinal channel portions extending along respective longitudinal axes at opposite sides of the central portion and defining opposite side edges of the manifold, each channel portion having at least one longitudinal ink supply channel extending along a length thereof; and
first and second rows of butting print chips mounted to a base of the manifold, the first row of butting print chips extending along the first channel portion and the second row of butting print chips extending along the opposite second channel portion, each print chip in the first row receiving ink from at least one ink supply channel in the first channel portion and each print chip in the second row receiving ink from at least one ink supply channel in the second channel portion,
wherein each of the first and second channel portions extends beyond the central portion at opposite ends of the manifold, such that respective opposite ends of the manifold have a re-entrant profile configured for complementary interleaving of a plurality of said printheads.

2. The inkjet printhead of claim 1, wherein the manifold has 180 degree rotational symmetry.

3. The inkjet printhead of claim 1, wherein the manifold has substantial mirror symmetry about its central longitudinal axis.

4. The inkjet printhead of claim 1, wherein the re-entrant profile at each end of the manifold contains exterior angles from 100 to 170 degrees.

5. The inkjet printhead of claim 4, wherein opposite ends of the manifold have a trapezoidal wave profile for complementary interleaving of neighboring printheads.

6. The inkjet printhead of claim 1, further comprising a first PCB mounted to the base of the manifold, the first PCB extending longitudinally along the manifold between the first and second rows of print chips.

7. The inkjet printhead of claim 1, wherein the first PCB extends into the first and second channel portions and has a re-entrant profile at opposite ends thereof mirroring the re-entrant profile at opposite ends of the manifold.

8. The inkjet printhead of claim 7, wherein the first PCB distributes power and data to both the first and second rows of print chips.

9. The inkjet printhead of claim 6, wherein the central portion defines a plurality of through-holes, and wherein each through-hole receives one or more electrical connectors for supplying power and data to the first PCB.

10. The inkjet printhead of claim 1, wherein the first channel portion contains first and second ink supply channels for supplying first and second inks to the first row of print chips, and the second channel portion contains third and fourth ink supply channels for supplying third and fourth inks to the second row of print chips.

11. The inkjet printhead of claim 1, wherein the manifold comprises molded upper and lower parts bonded together, wherein the lower part defines the ink supply channels and the upper part defines ink feed slots facing ink supply channels, each ink feed slot being co-extensive and aligned with its corresponding ink supply channel.

12. The inkjet printhead of claim 11, wherein each ink feed slot communicates with ink ports positioned towards opposite ends of the upper part, respectively.

13. The inkjet printhead of claim 12, wherein:
each ink supply channel meets with opposite endwalls of the lower part;
each ink feed slot meets with opposite endwalls of the upper part; and
each ink port is laterally offset from its respective ink feed slot and extends upwardly from the manifold.

14. The inkjet printhead of claim 13, wherein each ink port is longitudinally spaced apart from a respective endwall of the upper part, and wherein an ink passage interconnects the ink port with its respective ink feed slot.

15. The inkjet printhead of claim 14, wherein the ink port, the ink passage and the ink feed slot define a tortuous ink pathway.

16. The inkjet printhead of claim 11, wherein:
the first channel portion contains first and second ink feed slots corresponding to first and second ink supply channels; and
the second channel portion contains third and fourth ink feed slots corresponding to third and fourth ink supply channels.

17. The inkjet printhead of claim 16, wherein each ink feed slot communicates with a respective pressure dampener positioned above its respective ink feed slot, the pressure dampener comprising a membrane gasket configured for flexing in response to pressure fluctuations.

18. The inkjet printhead of claim 17, wherein each ink feed slot has a respective ink duct communicating ink pressure fluctuations from the ink feed slot to the membrane gasket, each ink duct having a larger volume than its corresponding ink feed duct to provide a locak ink reservoir supplying ink to the print chips.

19. The inkjet printhead of claim 18, wherein:
each pair of first and second ink ducts corresponding to first and second ink feed slots is covered by a respective first cover plate, the first cover plate urging a first membrane gasket against first and second duct walls to seal the first and second ink ducts; and
each pair of third and fourth ink ducts corresponding to third and fourth ink feed slots is covered by a respective second cover plate, the second cover plate urging a second membrane gasket against third and fourth duct walls to seal the third and fourth ink ducts.

20. A print bar comprising a plurality of printheads according to claim 1 in an interleaved array, whereby a first channel portion of a first printhead interleaves between first and second channel portions of a second printhead, such that:
a first row of print chips of the first printhead overlaps with a corresponding first row of print chips of the second printhead;
a second row of print chips of the first printhead overlaps with a corresponding second row of print chips of the second printhead.
